(19) United States
(12) Patent Application Publication
(10) Pub. No.: US 2011/0136086 A1
(43) Pub. Date: Jun. 9, 2011

(54) Systems and Methods for Generating Personality Profiles for Animals

(76) Inventors: Iain Saul, North Tamborine (AU); Letitia Fox-Varshavsky, Los Angeles, CA (US)

(21) Appl. No.: 12/960,342

(22) Filed: Dec. 3, 2010

Related U.S. Application Data
(60) Provisional application No. 61/266,260, filed on Dec. 3, 2009.

(51) Int. Cl. G09B 19/00

(52) U.S. Cl. 434/236

(57) ABSTRACT

A method of generating a personality profile of at least two animals to determine compatibility potential between the animals, comprises: obtaining a set of answers to a plurality of queries relating to a first of the animals; obtaining a set of answers to a plurality of queries relating to a second of the animals; tabulating each of the sets of answers to obtain an overall score for each of the animals; comparing the overall scores of each of the animals one to another; and determining a compatibility potential between the animals based upon the comparison of the overall scores.

### PRIORITY CLAIM

Priority is claimed of U.S. Provisional Patent Application Ser. No. 61/266,260, filed Dec. 3, 2009, which is hereby incorporated herein by reference in its entirety.

### FIELD OF THE INVENTION

1. Background

The present invention relates generally to systems used to evaluate animals and quantify the suitability of one or more animals for various purposes. More particularly, the present invention relates to systems used to evaluate animals to determine the compatibility potential between two or more animals.

2. Related Art

Just as humans have personality types it has been observed that animals likewise have differing personality types. Research has shown that there exist basic personality traits of the species, for instance, aggressive or timid. Further, individuals within that species will exhibit different temperament types, and, where there are differing breeds within that species, further dominant personality traits have been observed. As one example, a species could be identified as a horse. A breed of horse can include an Arabian horse. This breed is known to be highly strung, intelligent and have a natural tendency to cooperate with humans, but there are wide variations of these traits and within the breed. As no two humans are exactly alike, neither are two animals, even if they be the same species and breed.

### SUMMARY OF THE INVENTION

The present invention provides a method of generating a personality profile of at least two animals to determine compatibility potential between the animals, comprising: obtaining a set of answers to a plurality of queries relating to a first of the animals; obtaining a set of answers to a plurality of queries relating to a second of the animals; compiling each of the sets of answers to obtain an overall score for each of the animals; comparing the overall scores of each of the animals one to another; and determining a compatibility potential between the animals based upon the comparison of the overall scores.

In accordance with another aspect of the invention, a system for generating a personality profile of at least two animals to determine compatibility potential between the animals is provided, including at least one score matrix on which a set of answers to a plurality of queries relating to a first of the animals can be recorded. A second score matrix on which a set of answers to a plurality of queries relating to a second of the animals can be recorded. Wherein each score matrix includes at least some fields which correlate to descriptive matter provided relating to generalized personality traits, and wherein each score matrix includes an overall score field in which an overall score for each of the animals can be recorded.

There has thus been outlined, rather broadly, the more important features of the invention so that the detailed description thereof that follows may be better understood, and so that the present contribution to the art may be better appreciated. Other features of the present invention will become clearer from the following detailed description of the invention, taken with the accompanying drawings and claims, or may be learned by the practice of the invention.

### BRIEF DESCRIPTION OF THE DRAWINGS

FIG. 1 illustrates an exemplary characteristics card in accordance with an embodiment of the invention that can be utilized to provide generalized human characteristics associated with the color orange;

FIG. 2 illustrates an exemplary characteristics card in accordance with an embodiment of the invention that can be utilized to provide generalized canine characteristics associated with the color orange;

FIG. 3 illustrates an exemplary score matrix on or in which a compatibility score can be tabulated for a human; and

FIG. 4 illustrates an exemplary score matrix on or in which a compatibility score can be tabulated for a canine.

### DETAILED DESCRIPTION

Before the present invention is disclosed and described, it is to be understood that this invention is not limited to the particular structures, process steps, or materials disclosed herein, but is extended to equivalents thereof as would be recognized by those of ordinarily skilled in the relevant arts. It should also be understood that terminology employed herein is used for the purpose of describing particular embodiments only and is not intended to be limiting.

It must be noted that, as used in this specification and the appended claims, the singular forms “a” and “the” include plural referents, unless the context clearly dictates otherwise. Thus, for example, reference to a “matrix” can include reference to one or more of such matrixes.

### DEFINITIONS

In describing and claiming the present invention, the following terminology will be used in accordance with the definitions set forth below.

As used herein, the term “animal” can be used to refer to a wide range of animals, including, without limitation, mammals, reptiles, aquatic animals, humans, canines, horses, felines, and livestock. The present invention can be used to evaluate any type of animal whose mannerisms, reactions, temperament, etc., are capable of being analyzed by human evaluation.

As used herein, the term “substantially” refers to the complete, or nearly complete, extent or degree of an action, characteristic, property, state, structure, item, or result. As an arbitrary example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained.

The use of “substantially” is equally applicable when used in a negative connotation to refer to the complete or near complete lack of an action, characteristic, property, state, structure, item, or result. As another arbitrary example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, the term “about” is used to provide flexibility to a numerical range endpoint by providing that a given value may be “a little above” or “a little below” the endpoint.

Distances, forces, weights, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited.

As an illustration, a numerical range of “about 1 inch to about 5 inches” should be interpreted to include not only the explicitly recited values of about 1 inch to about 5 inches, but also include individual values and sub-ranges within the indicated range. Thus, included in this numerical range are individual values such as 2, 3, and 4 and sub-ranges such as from 1-3, from 2-4, and from 3-5, etc.

This same principle applies to ranges reciting only one numerical value and should apply regardless of the breadth of the range or the characteristics being described.

### INVENTION

The present invention can be used to define a personality trait of an animal, and to provide a personality type definition. In one embodiment, the system defines the significant personality categories of firstly the species of the animal; then any breeds within that species and further, to indicate an individual animal's personality. The system can utilize words, numbers, letters, colors (or a variety of other, meaningful expressions) to define a certain personality trait or personality type.

The invention relates not only to the assessment and profiling of the personality of animals, but also to the interaction of the animal's predicted behavior with a human's predicted behavior; and/or to another animal's predicted behavior. While the present invention can be applied to a wide range of animals, it is particularly well suited for application to animals that constitute “pets” and their owners (or prospective owners). Thus, the invention encompasses evaluating or predicting the personality of both the pet owner and the pet itself, and applies that information particularly to the interaction of the owner and the pet. The same techniques can also be applied between animals of the same nature; e.g., to predict or evaluate how two pet dogs will interact together.

In the discussion to follow, and in the figures, the system is described by using a human and a dog as examples. Importantly, the present invention is not limited to use with any particular animal: the human and the dog are used as examples only. Also, as shown and described, the invention is carried out utilizing a series of cards or pamphlets that can be physically held and read by a user. The present invention can also be utilized on a computing system that includes a monitor for displaying information and data, and for allowing a user to input data. One of ordinary skill in the art would readily appreciate that the invention can be easily adapted for use with a personal computer, an internet application, cell phones, PDAs and the like.

The invention can be used to quickly assess the personality types of both pet and human and, in one aspect, obtain a close compatibility match between the two. This can be particularly advantageous, and can be readily implemented, by animal refuges, “pounds,” shelters and the like, where people often visit seeking pets. The system can advantageously allow such entities to better match a pet to a prospective owner. Further, the system can be utilized to allow a human to better understand and relate to a pet they recently adopted, or to an existing pets.

In one most basic embodiment, the invention can include an instruction manual that describes how the system works, and describes various animal personality types. The manual can then educate and instruct a person how to recognize personality traits through the breed of the animal. This information can be further refined by both general passive observation and/or by setting tasks or games for the subject animals and evaluating the animal's performance or response thereto. The manual can include dual modalities: including a section that identifies a personality type of an animal and a further section that identifies a personality type of a human (e.g., the pet owner or potential pet owner). The manual can be provided in a number of formats, including, without limitation, written text, voice instructions, and/or analogue or digital electronic format.

Generally speaking, a manual provided with the present invention will describe a system whereby both the animal personality type and the human personality type can be determined and/or labeled or defined in a simple manner. The system can provide personality “typing” and interaction of all combinations of the following: owner to pet matching; pet to pet matching; pet to owner matching; and pet to other humans matching (e.g., matching of a potential pet to people who often associate with the potential owner, such as grandchildren, friends, etc.). Thus, the system provides a multiplicity of possible personality interaction predictions and can predict or establish optimal profiles for both human and animal.

In one exemplary embodiment, an animal refuge society may wish to assess a dog's personality so as to find the best fit with a potential new owner. Personnel at the animal refuge can be trained in the present methodology and can be provided reference to the manual. The personnel can then apply the assessment criteria to the subject animal and produce personality type profile of the animal. A person wishing to acquire a dog would then be asked to undertake a simple personality typing evaluation to determine his or her personality type. This information can be used to find the best fit with regard to a particular dog type.

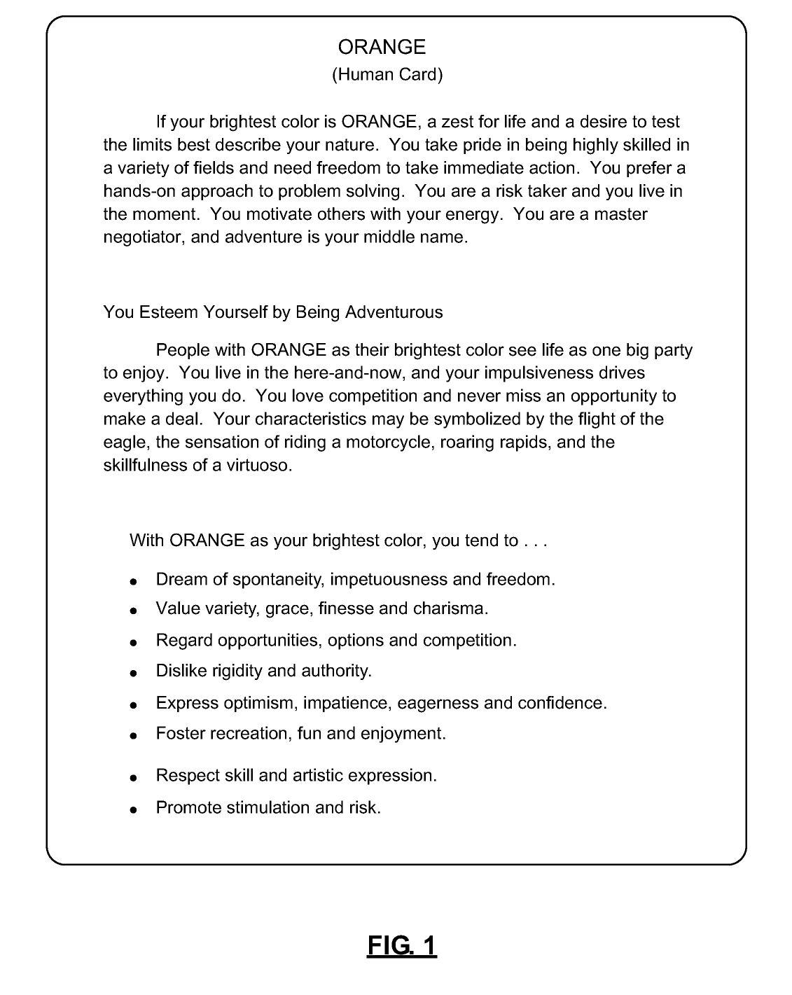

The human personality test can include a variety of tests, including tests collated by various “color” personality traits. For example, a person can be presented with four colored cards that have written thereon various character traits associated with a particular personality type. One non-limiting example of such a card is shown in FIG. 1. In this example, information is presented on a substrate, such as a cardboard or cardstock “card,” that relates to various personality traits of a human that are categorized under the color orange. While not so required, in a typical application, four or five such cards can be presented, each having generalized personality information relating to a specific color (e.g., orange, gold, blue, green, etc.).

Upon reading all of the colored cards, the person can then be asked to prioritize the cards from most like them to least like them. In this manner, a spectrum of four colors can be generated. Based upon this data, the animal refuge can then recommend a dog breed type, and, from within that breed type, a particular dog.

In one simplistic embodiment, a methodology has been developed for profiling an animal's personality based on “breed” that uses the simplified system of assigning a color to a particular breed personality type. As an example, if the colors violet, blue, green, yellow, orange, red were assigned to personality traits, red may be assigned to aggression, blue to affectionate; green can be assigned to an inquisitive problem solver, etc. The animal's personality can then be simply described by a spectrum of the colors: for example, starting with the most dominant categorized trait to the least applicable categorized personality trait. This is further modified as to whether or not the subject is introverted or extroverted. Thus, in this example, the animal may be defined as having an orange-green-violet-blue-yellow-red, introverted or extroverted personality.

Research has shown that just four or five main personality types are presented by most types of animals. In many cases, only four colors are sufficient for adequately assessing and defining both an animal's and a human's personality. Research has determined that certain breeds of dog have a predominant personality type, often based upon what characteristic they originally had bred into them. As such, when using the various color cards shown and explained herein, a breed's predominant characteristics can be defined by colors.

However, this does not presume that all dogs within that breed will have that particular personality. As such, the present system can be utilized to recognize individual traits and produce a colored spectrum customized to each individual dog. There have been developed many methods to identify the individual dog's traits without regard to breed. Some examples of these methodologies are: The Safer Aggression Test/MYM Safer Test developed by Dr. Emily Weiss; the Assess-a-Pet™ system developed by Sue Sternberg; the ATTS Temperament Test, and the like. All of the above-named systems assess the dog's personality by challenging the dog in some form of test. Each of these systems requires that a trained person is in contact with the dog for some period of time.

In one example of the present invention, a dog's personality traits may be characterized by way of a color “score.” For example, a German Shepherd, also known as an Alsatian, may be defied as having a “Gold” personality trait. This being: “I am at my best when there is a daily schedule and a regular routine. It gives me a sense of order when I know what is expected of me and others. I am smart, stable, loyal, and respectful. I need to be useful and enjoy having a job to do that is a regular part of my day. I am a flock-guarding dog, which means that I will try to control people and environments if I'm not given certain tasks. I will start to feel insecure if I do not know my specific job. For example, when guests come to the door and knock or ring the doorbell, what should I do? I am a working dog but can exist in a pet home if the family is willing to train me and keep a step ahead of me. I thrive on routine and predictability and need a sense of order. I like for my owners to feel proud of me. I like to be of service and make a great companion.”

However, not all German Shepherds (e.g., Alsatians) will exhibit the same characteristics to the same degree. A characteristic secondary to that of the breed characteristic may be more dominant. For example, dogs, like humans, may exhibit extroverted and introverted personalities. Thus, under the present system, a German Shepherd dog could be identified as introverted and may exhibit a “Blue” dominant personality. The characteristics of this label can include: “I love affection, crave attention, and enjoy spending time with you. I need a warm and cozy place to live. I am here to make my owner happy; if you're happy, I'm happy. I love to be touched, hugged, loved, and admired. I am sensitive, smart, and loyal. I am also methodical and deliberate. I need security because I tend to easily become over-attached once we've bonded. I count on you and like knowing that you'll come back to me.”

In another exemplary embodiment, the system can include four cards that are each designated to a human personality type. Each of the four cards can be characterized by a color and a corresponding graphic image on one side and descriptive text upon the other side (see, for example, the human Orange card illustrated in FIG. 1). The textual description can describe the personality traits of the person associated with a particular color, which person can thereafter be designated by that color. Similarly, the system can also contain four cards corresponding to an animal personality type, in the example shown, various dog personality types.

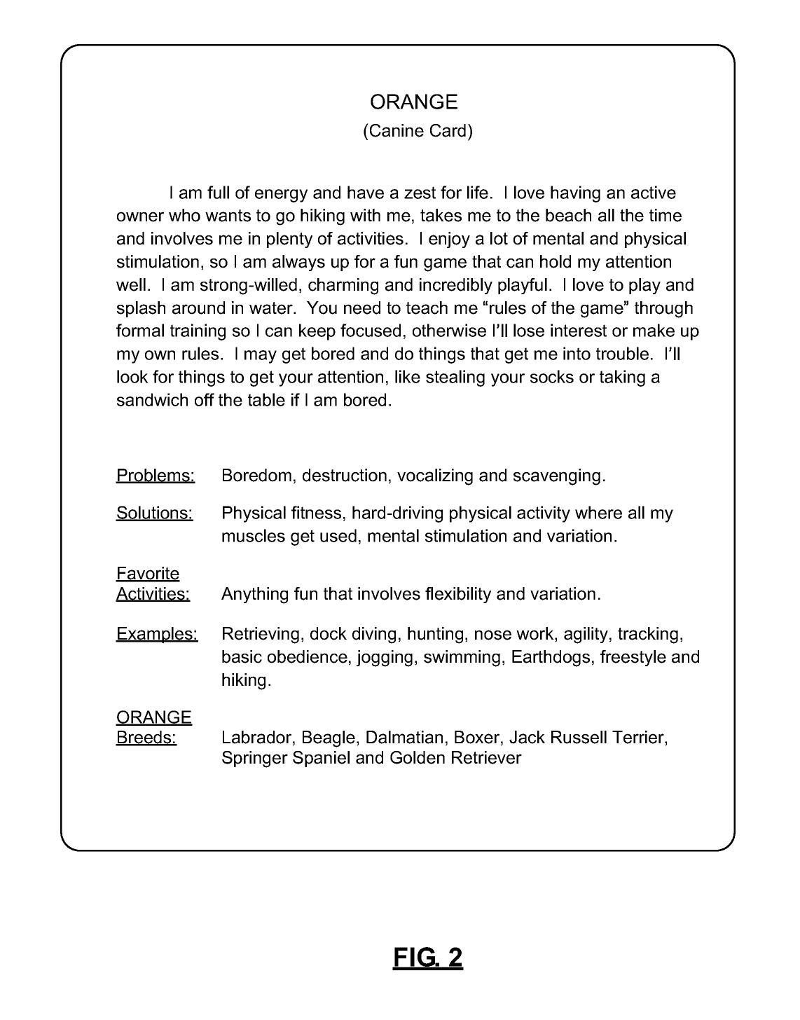

Each of the four dog personality types can be associated with a color, with a graphic images presented on one side of a card depicting some of the breed types associated with the personality types. Textual description can be included on reverse sides of the cards (see, for example, the exemplary canine orange card illustrated in FIG. 2). The accompanying textual description can expand upon the personality traits of the breed associated with, and thereafter designated by, that particular color.

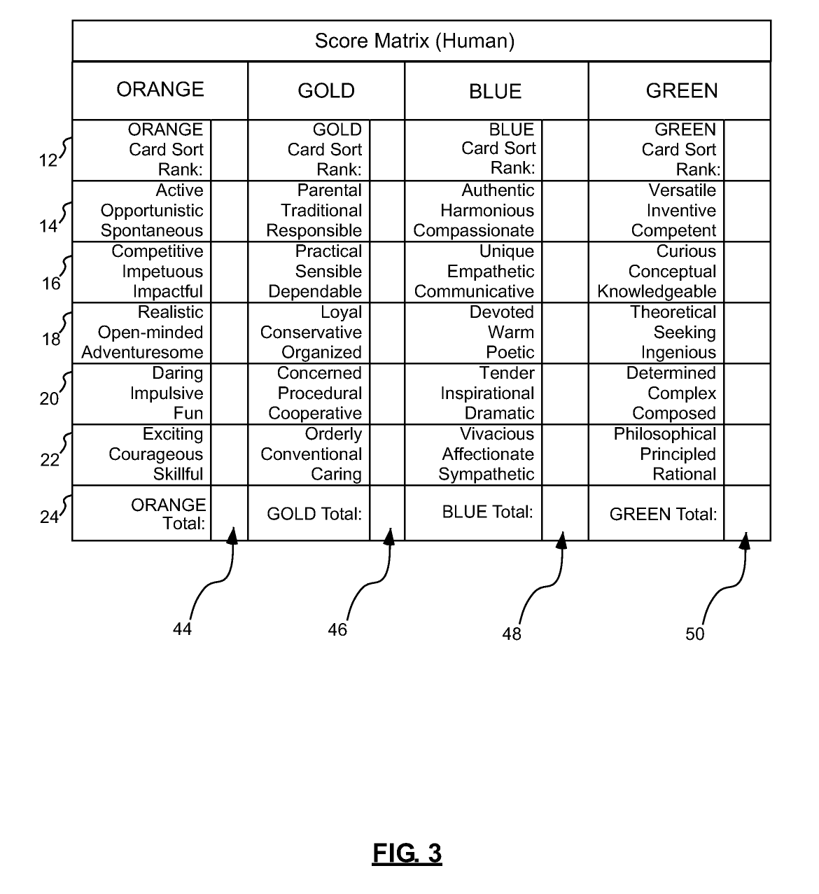

The system can include instructions directing a user on how to best utilize the cards along with a more in-depth coverage of the various animal personality types. For example, a user can be prompted to refer to all of the “human cards” and can be directed to the portion of the manual where a matrix of questions can be used to indicate and assess personality type spectrum. Firstly the graphics on the human cards are reviewed and prioritized as to the card the user most associates him- or herself to the card the user least associates him- or herself with. With reference to FIG. 3, for example, the human can assign, in row 12, a relative score for each color type (e.g., a “1,” “2,” “3,” or “4” can be inserted in each Card Sort Rank field), depending upon how the human ranks his- or her-self based on the information presented on or by the orange, gold, blue and green information cards. This information can then be recorded within the matrix.

Next, the cards can be turned over and the text associated with each card can be read and the matrix can be filled in with information, again ranking or prioritizing the options from “most like the person” to “least like the person.” The user can read the text within the matrix and can record answers in each slot of the matrix, again ranking the answers from “most like the person” to “least like the person.” For example, in each of the fields of rows 14 through 22, the user can enter a score of 1 through 4. By tabulated each of the columns (e.g., Orange, Gold, Blue and Green) in row 24, the matrix will then produce a determination of the user's color spectrum, producing a total for each color 44, 46, 48, 50, etc.

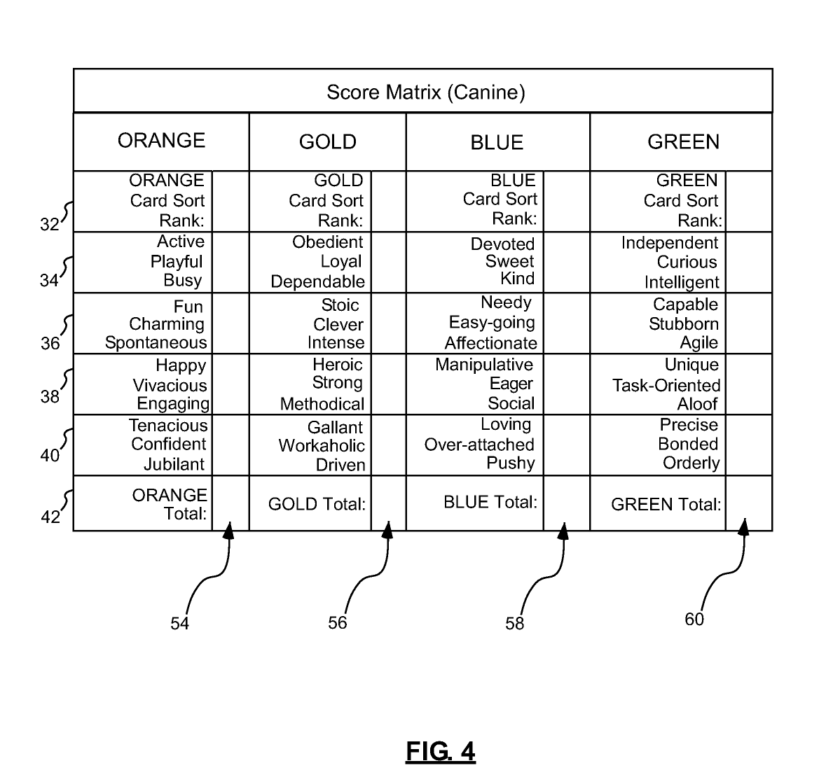

A similar procedure can be undertaken to obtain a color spectrum for the potential pet (see, e.g., FIG. 4), where data fields can be entered in rows 32 through 40, and totals tabulated in row 42 to produce a score for each color at 54, 56, 58, 60, etc. The color spectrum obtained can be based upon an assessment of a pet's actual disposition, or based upon a potential pet owner's desired disposition. Thus, in one embodiment, the potential pet owner can generate (through answering of questions presented in the matrix) a color spectrum for his or her “ideal” pet. The method can include performing the color spectrum analysis for a particular pet, to achieve the most closely matched color spectrum to that identified by (or for) a particular potential pet owner.

The system can also include the further step of assessing the dog breed personality and observing if the dog exhibits a dominant, extrovert personality or a more submissive, introverted personality.

The present system thus provides a manner of ranking humans and/or pets across a broad spectrum of characteristics. Not only will the calculation for each human or dog produce a dominant color (e.g., that total in row 24 or 42 that is the highest), but will also produce a score for the remaining colors that can aid in refining the evaluation of the human and pet. This can be advantageous, for example, in cases where multiple pets match a human's primary color score, but only one or two may match his or her score in the remaining color fields.

The use of the primary ranking of color in row 12 functions in a similar manner. For example, while a human may be relative certain that he or she is more of an “orange” person than a “green” person, the system provides a more sophisticated matching analysis than simply pairing the human with an “orange” pet. Certain humans and animals may be more or less “orange,” and so may be better matches for one another. In one exemplary embodiment, each person or pet can be provided with a color-spectrum score that is generated by the scores tallied for each color (e.g., a human may be an orange-gold-blue-green personality type, whereas a potential pet may be an orange-blue-green-gold personality type). These subtleties in differences can aid in providing a more accurate match between humans and pets (or between pets and pets, when applicable).

It is to be understood that the above-described arrangements are only illustrative of the application of the principles of the present invention. Numerous modifications and alternative arrangements may be devised by those skilled in the art without departing from the spirit and scope of the present invention and the appended claims are intended to cover such modifications and arrangements. Thus, while the present invention has been described above with particularity and detail in connection with what is presently deemed to be the most practical and preferred embodiments of the invention, it will be apparent to those of ordinary skill in the art that numerous modifications, including, but not limited to, variations in size, materials, shape, form, function and manner of operation, assembly and use may be made without departing from the principles and concepts set forth herein.

We claim:

1. A method of generating a personality profile of at least two animals to determine compatibility potential between the animals, comprising:
obtaining a set of answers to a plurality of queries relating to a first of the animals;
obtaining a set of answers to a plurality of queries relating to a second of the animals;
tabulating each of the sets of answers to obtain an overall score for each of the animals;
comparing the overall scores of each of the animals one to another; and
determining a compatibility potential between the animals based upon the comparison of the overall scores.

2. The method of claim 1, wherein the first animal is a human, and wherein the second animal is a pet.

3. The method of claim 2, wherein each of the sets of answers is generated by the human, with the second set of answers generated based on the human's perceived desirable attributes of the pet.

4. The method of claim 2, wherein each of the sets of answers is generated by the human, with the second set of answers generated based on actual attributes of the pet perceived by the human.

5. The method of claim 2, wherein the set of answers relating to the pet are pre-generated based on a breed and/or species of the pet.

6. The method of claim 1, wherein at least some of the queries or the answers relate to a color scheme: and wherein sets of answers include a multi-color scale score.

7. The method of claim 6, wherein the multi-color scale score includes a numeric ranking of 4 or more colors for each of the animals.

8. The method of claim 1, wherein each of the animals comprises a pet.

9. A system for generating a personality profile of at least two animals to determine compatibility potential between the animals, comprising:
a score matrix on which a set of answers to a plurality of queries relating to a first of the animals can be recorded;
a second score matrix on which a set of answers to a plurality of queries relating to a second of the animals can be recorded;
each score matrix including at least some fields which correlate to descriptive matter provided relating to generalized personality traits; and
each score matrix including an overall score field in which an overall score for each of the animals can be recorded.

10. The system of claim 9, wherein the score matrix is recorded on a substrate.

11. The system of claim 9, wherein the score matrix is recorded on an electronic medium.

12. The system of claim 11, wherein comparing the overall sores of each of the animals and determining a compatibility potential between the animals is executed by an electronic computing device.

13. The system of claim 9, wherein the first animal is a human, and wherein the second animal is a pet.

14. The system of claim 13, wherein each of the sets of answers is generated by the human, with the second set of answers generated based on the human's perceived desirable attributes of the pet.

15. The system of claim 13, wherein each of the sets of answers is generated by the human, with the second set of answers generated based on actual attributes of the pet perceived by the human.

16. The system of claim 13, wherein the set of answers relating to the pet are pre-generated based on a breed and/or species of the pet.

17. The system of claim 1, wherein at least some of the descriptive matter provided relating to generalized personality traits relates to a color scheme: and wherein at least some of the sets of answers on the score matrix include a multi-color scale score.

18. The system of claim 17, wherein the multi-color scale score includes a numeric ranking of 4 or more colors for each of the animals.

19. The system of claim 9, wherein each of the animals comprises a pet.
